(19) United States
(12) Patent Application Publication
(10) Pub. No.: US 2017/0291448 A1
(43) Pub. Date: Oct. 12, 2017

(54) SPRAG CLUTCH CASSETTE DRIVER

(71) Applicants: Ryan Miller, Jacksonville, FL (US); Marcus Polito, Jacksonville, FL (US); Ryan Rillstone, Jacksonville, FL (US)

(72) Inventors: Ryan Miller, Jacksonville, FL (US); Marcus Polito, Jacksonville, FL (US); Ryan Rillstone, Jacksonville, FL (US)

(73) Assignee: University of North Florida Board of Trustees, Jacksonville, FL (US)

(21) Appl. No.: 15/481,107

(22) Filed: Apr. 6, 2017

Related U.S. Application Data
(60) Provisional application No. 62/318,799, filed on Apr. 6, 2016.

(51) Int. Cl. B60B 27/00; F16D 41/24; B60B 27/02

(52) U.S. Cl. CPC B60B 27/00; B60B 27/02; F16D 41/24; B60B 2900/1212; B60B 2900/212

(57) ABSTRACT

A sprag one-way clutch (OWC) used within a cassette driver of the rear hub assembly of a bicycle. The new cassette driver delivers improved performance the reduction of rotation of the crank arm required before engagement within the cassette driver when the cyclist applies force to the pedals. Additionally, the sprag clutch smooth engagement minimizes friction loss during free-wheeling, therefore increasing drivetrain efficiency. These enhancements provide both safety and performance benefits by giving the cyclist greater control in moving between pedaling and free-wheeling. The current cassette driver design utilizes a sprag OWC for engagement without any modifications to current bicycle designs. A sprag cage may be used to provide a framework to support and properly position the sprags.

### CROSS-REFERENCE TO RELATED APPLICATIONS

This nonprovisional application is claims priority to U.S. Provisional Patent Application No. 62/318,799, entitled “Sprag Clutch Cassette Driver”, filed Apr. 6^{th}, 2016 by the same inventors, the entirety of which is incorporated herein by reference.

### BACKGROUND OF THE INVENTION

### 1. Field of the Invention

This invention relates, generally, to bicycle drivetrains. More specifically, it relates to sprag clutch cassette drivers.

### 2. Brief Description of the Prior Art

The majority of recreational mountain bicycles utilize a ratchet and pawl clutch system in the rear wheel hub which allows for the transfer of torque to the rear wheel when pedaling in one direction and free rotation if pedaling in the opposite direction. As seen in FIG. 5, the pawl can have a significant gap in between teeth on the ratchet before the pawl engages the outer race of the system and torque is transferred to the wheel. On the other hand, a sprag system engages much quicker due to the rotation of the sprag engaging the outer race to transfer torque just based off its orientation within the clutch system. As seen in FIG. 6, the sprag engages once the inner race rotates causing the sprags to wedge themselves between the inner and outer race. The setup allows for a much shorter, consistent gap of engagement as well as an increase in the durability of the system by having more points of engagement in comparison to the original system. The smoother, instantaneous engagement allows for less severe impact loading on the clutch system when the cyclist quickly transfers torque to the hub.

Cyclists of all genres desire a drivetrain/clutch that minimizes engagement time and weight, while maximizing durability and performance. Freewheeling bicycle hubs enable rotation of bicycle pedals to drive rotation of the bicycle wheels; the difference is that these types of hubs also allow the bicycle wheels to rotate even if the bicycle pedals are not rotated. This functionality enables the pedals of the bike to be held stationary while the wheels rotate as the bike coasts. An example of a freewheel hub that attempts to provide this benefit is U.S. Pat. No. 9,102,197. However, it does not completely accomplish this goal in a cost-effective manner, as friction loss during freewheeling should be minimized to preserve the cyclist's energy and enhance performance of the bicycle.

Accordingly, what is needed is a simple and cost-effective way for a cyclist to increase overall performance and safety while cycling. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION OF THE DRAWINGS

For a fuller understanding of the invention, reference should be made to the following detailed description, taken in connection with the accompanying drawings, in which:

FIG. 1A is a cross-sectional view of an embodiment of the current invention.

FIG. 1B is a perspective view of the embodiment of FIG. 1A.

FIG. 1C is a semi-exploded view of the embodiment of FIG. 1A.

FIG. 2 is a perspective view of a freehub shell, according to an embodiment of the current invention.

FIG. 3 is a perspective view of an inner race, according to an embodiment of the current invention.

FIG. 4 is a perspective view of a sprag, according to an embodiment of the current invention.

FIG. 5 depicts a conventional ratchet and pawl clutch system.

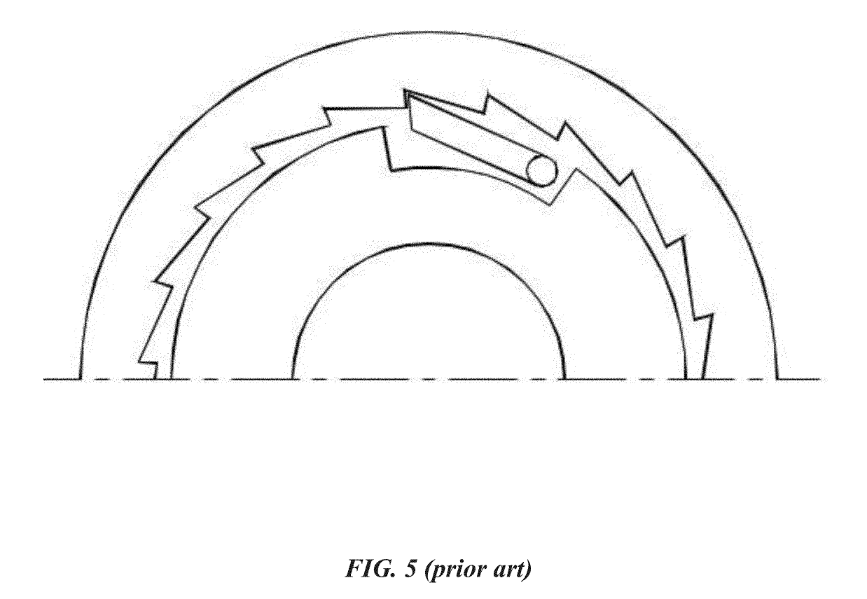

FIG. 6 depicts a conventional sprag clutch system.

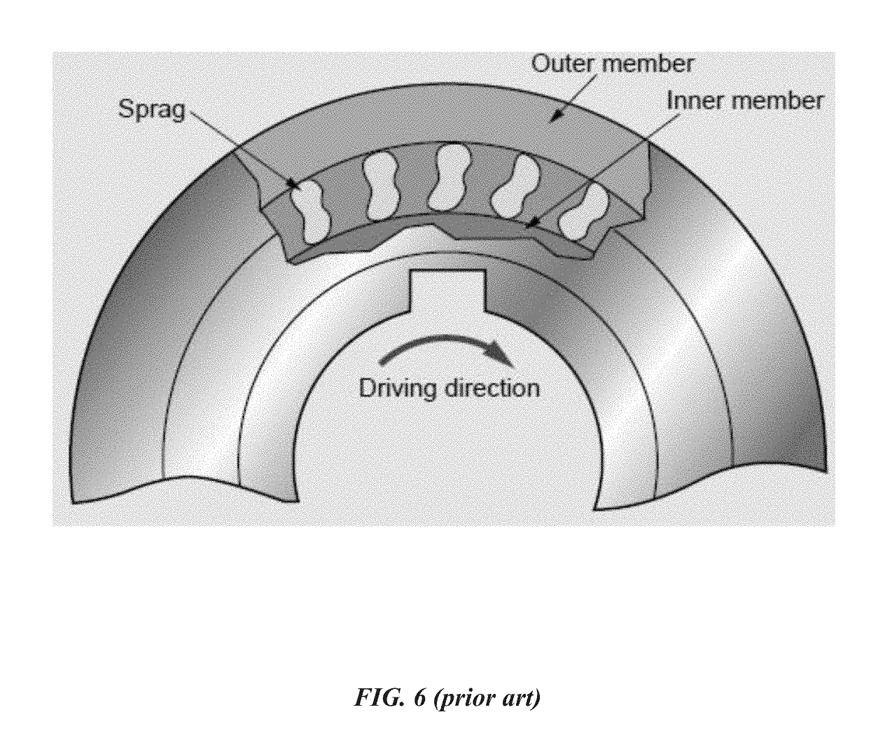

FIG. 7 is an illustration defining race variables of a conventional sprag one-way clutch design.

FIG. 8 is an illustration defining race/sprag forces and strut angle of a conventional sprag one-way clutch design.

FIG. 9 depicts a sprag clutch assembly, according to an embodiment of the current invention.

FIG. 10 depicts top and side views of an outer race, according to an embodiment of the current invention.

FIG. 11 depicts top and side views of an inner race, according to an embodiment of the current invention.

FIG. 12 depicts side and end views of a sprag, according to an embodiment of the current invention.

FIG. 13 depicts various views and schematics of a sprag cage, according to an embodiment of the current invention.

FIG. 14A depicts a sprag cage implemented on the assembly, according to an embodiment of the current invention.

FIG. 14B is another view of the sprag cage assembly of FIG. 14A.

FIG. 15A is an exploded view of an embodiment of the current invention with sprag cage and sprags assembled.

FIG. 15B is an exploded view of an embodiment of the current invention with sprag cage and sprags separated.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

In an embodiment, the current invention includes a sprag one-way clutch (OWC) used within a cassette driver of the rear hub assembly of a bicycle. A sprag OWC integrated design ensures that certain qualities meet or exceed current bicycle drivetrain standards. The new cassette driver delivers improved performance the reduction of rotation of the crank arm required before engagement within the cassette driver when the cyclist applies force to the pedals.

Additionally, the sprag clutch smooth engagement minimizes friction loss during free-wheeling, therefore increasing drivetrain efficiency. These enhancements provide both safety and performance benefits by giving the cyclist greater control in moving between pedaling and free-wheeling.

Another element of the OWC involves ease of installation which would allow for the sprag clutch system to seamlessly replace existing bicycle hub housings either during the manufacturing stage or as a post-purchase add-on.

The current invention allows for improved bicycle drivetrain efficiency by reducing freewheeling friction-loss, silent operation (eliminates the noise caused by the industry standard ratchet and pawl mechanisms) and improved engagement predictability. The current cassette driver design utilizes a sprag OWC for engagement without any modifications to current bicycle designs. Current rear wheel assemblies that utilize sprag clutches requires replacement of the entire rear hub assembly which significantly increases the expense and effort of upgrading.

Finite elemental analysis was performed on the current cassette driver design to ensure the assembly would withstand stresses induced by intense cycling.

### EXAMPLE 1

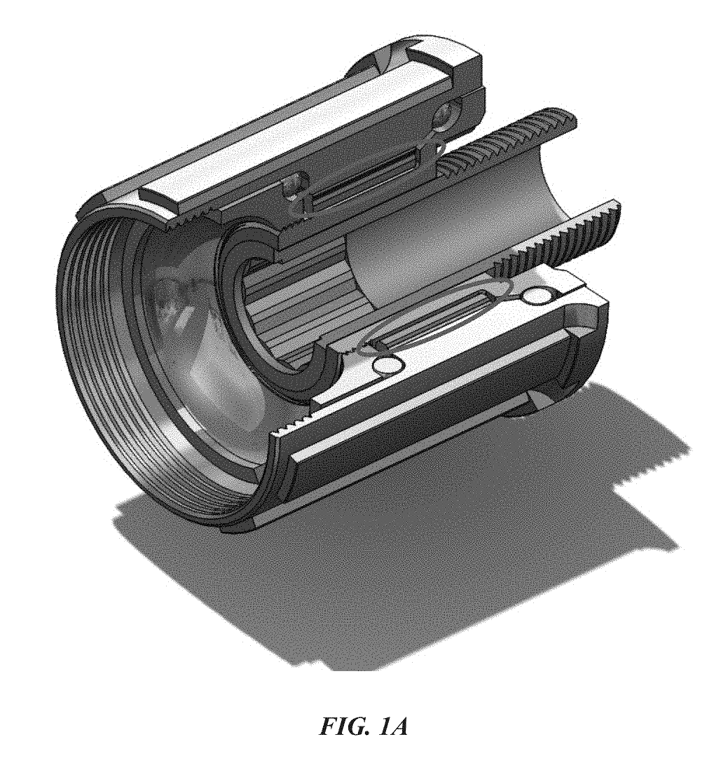

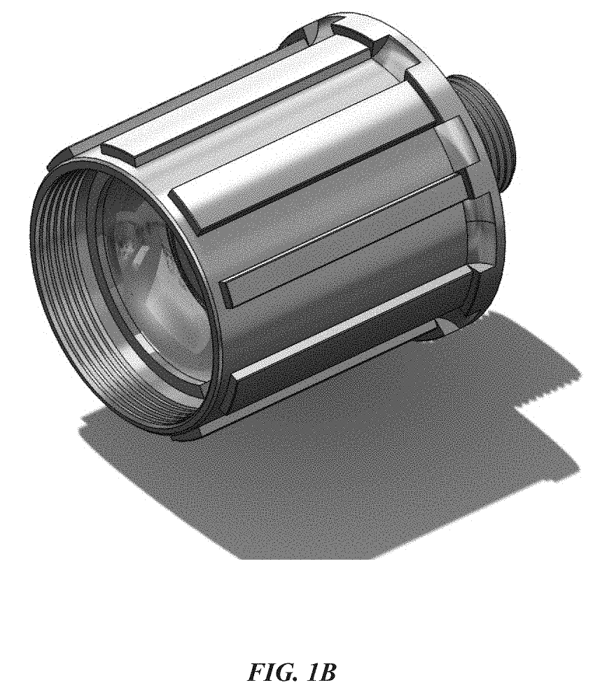

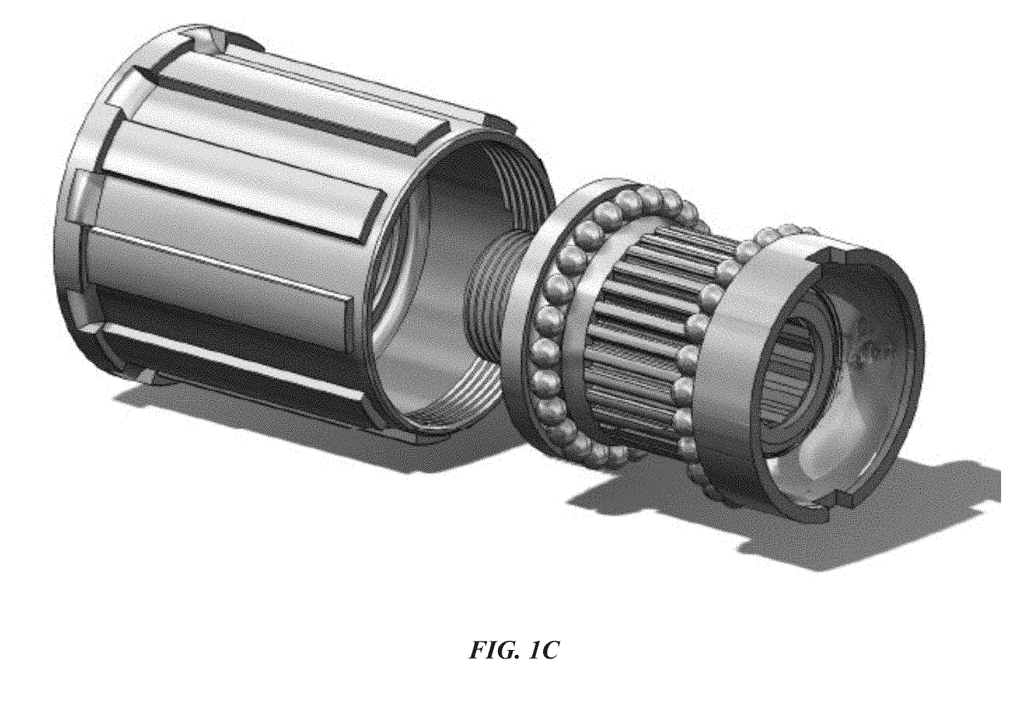

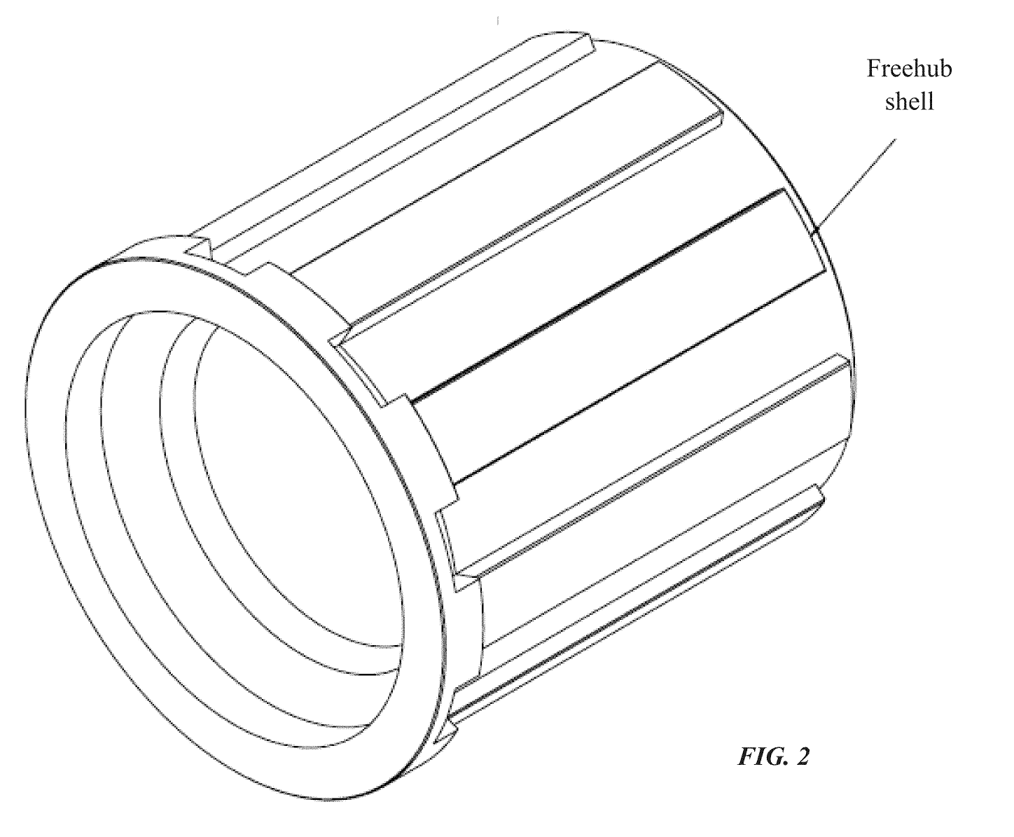

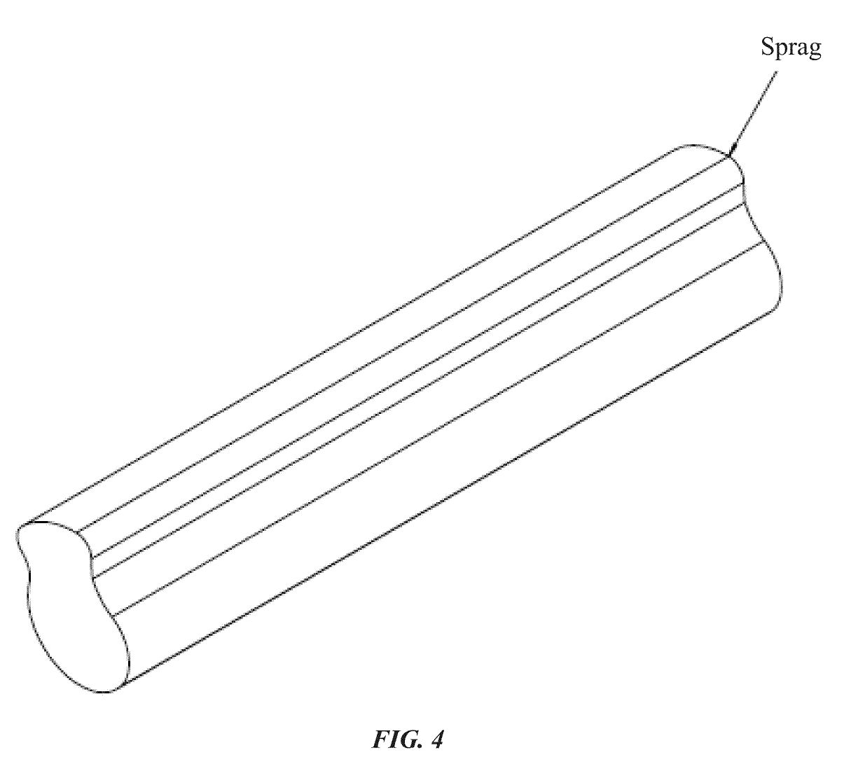

In an embodiment, as can be seen in FIG. 1A-1C and 2-4 the sprag clutch is positioned in the annular cavity within the cassette driver of the bicycle. The sprags contact the exterior surface of the inner race and the interior surface of the cassette driver shell. The sprags only come in contact with surfaces within the cassette driver.

It is well-known to remove the clutch mechanism from a bicycle's hub itself and place it into a cassette driver, considering many cassette drivers have a clutch mechanism. However, most, if not all, bicycles available use a ratchet and pawl mechanism in the cassette driver. However, using a sprag clutch mechanism within the cassette driver, as in the current invention, is novel and non-obvious as it provides the benefits of a sprag and clutch mechanism, while greatly reducing the cost to gain these benefits when compared to replacing an entire rear wheel hub. It can even be said that the current cassette driver essentially is the sprag clutch. The inner and outer race of the sprag clutch are not found in the conventional art. Further, the sprags and sprag retainers of the instant invention contact completely different components (in the cassette driver) than seen in the conventional art.

### EXAMPLE 2

It is an object of the current invention to provide instantaneous engagement, reliability, and a quieter ride, which can be provided by a sprag clutch fitted into a new or existing bicycle hub, specifically in the cassette driver. In designing this embodiment of the current invention, the sprag clutch must be able to withstand an infinite number of cycles without failing due to the fact that a hub failing could result in serious injury to the bicycle user if the wheel seizes from clutch failure. The clutch must also operate with the intended purpose of the sprags.

### Methodology

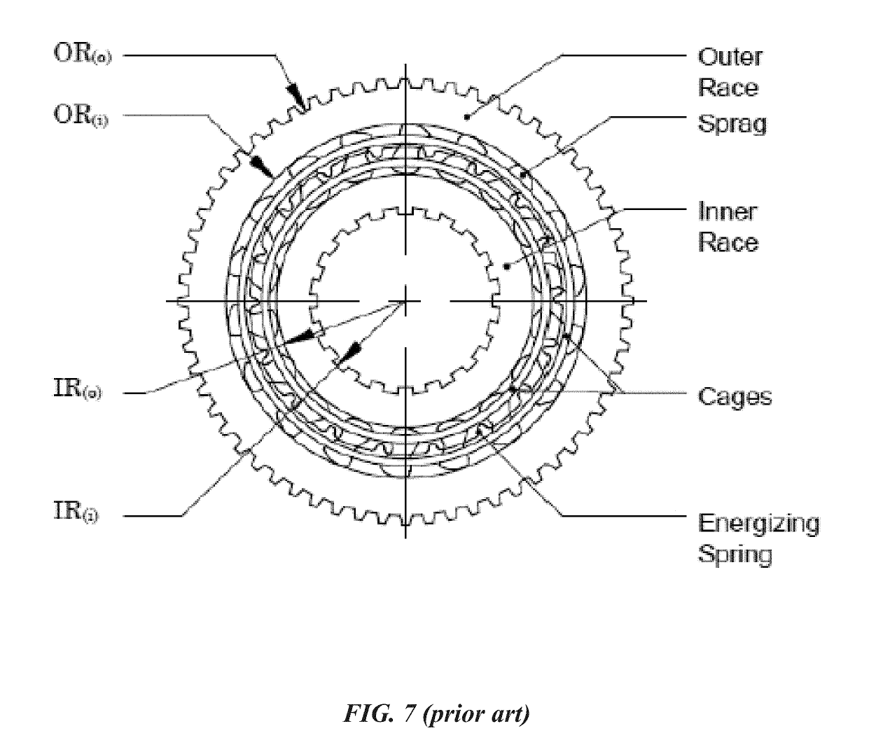

The magnitude of torque applied by the rider is dependent upon their weight. However, the force on each sprag is ultimately determined by the radii of the races. The radii are constrained by the typical cassette driver body size, for a seamless integration of use. If not, either a different cassette driver body or integrating the clutch within the wheel hub shell is needed. The dimensions of a typical cassette driver are then required to begin design. Having a size constraint, dimensions can help speed up an iterative approach to determine the factors of safety. The race variables used and locations are defined in FIG. 7.

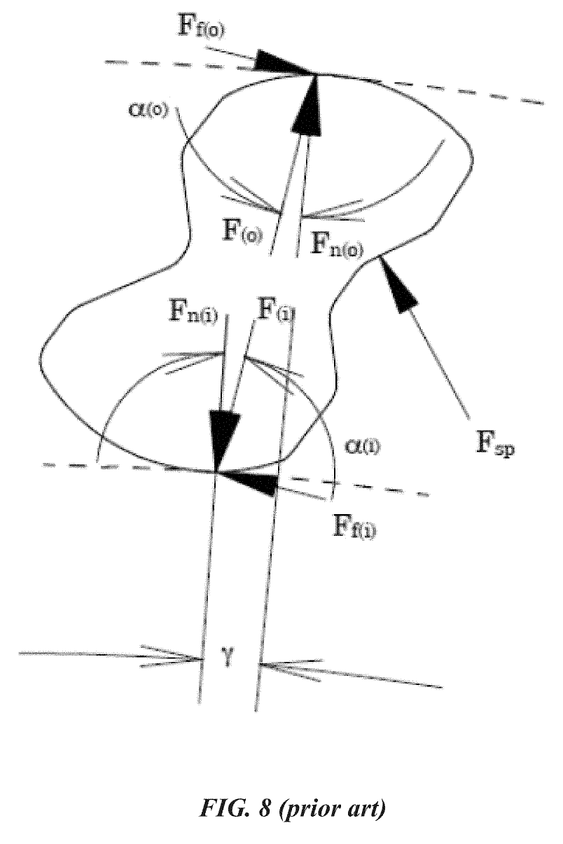

The outer race can be one piece with the outer shell of the cassette driver body and its longitudinal splines, providing for more material. The inner race can be one piece and also mate to the wheel hub to transmit torque. The inner radius of the outer race was initially guessed to find the tangential and normal forces on the sprag. The tangential force is the frictional force that prevents the sprag from slipping. The total frictional force from all sprags must be at least as great as the torque from the rider. Because it is a component of the total force, the total force on the sprag can be found through a trigonometric relationship. FIG. 8 displays the orientation of the forces resulting from the interaction of the sprag and races.

The frictional force is given in the following equation.

F_{friction}=Fₒᵤₜₑᵣ*sin(α) (1)

The interaction between the sprag and outer radius of the inner race can experience a greater total force.

$${F}_{inner} = \frac{T}{{N}_{sprags} * {OR}_{inner} * sin ( α )} \qquad ( 2 )$$

As the sprag engages between the two races, the strut angle, displayed previously in FIG. 8, increases up until a point where it pops, slips, or worse roll over inevitably losing all functionality. The force determined on the sprag can be used to determine this maximum strut angle by following Equations 3-5.

$$\frac{{F}_{friction}}{{F}_{normal}} = \frac{{F}_{inner} * sin ( α )}{{F}_{inner} * cos ( α )} = tan ( α ) \qquad ( 3 )$$

The frictional force or the tangential force is

F_{friction}≦μ_{static}*Fₙₒᵣₘₐₗ (4)

and substituting in, it can be shown

αᵢₙₙₑᵣ≦tan⁻¹(μ_{static}) (5)

The strut angle can be important in the design aspect because as the strut angle increases, the total force on the sprag decreases. Additionally, the total force on the sprag decreases as does the stress found in the races of the clutch races.

The width of the sprags and races is also constrained by the dimensions of the application. Dropouts of bike frames limit the overall width of the hub assembly. The sprags and races have the same width to eliminate non-uniform deflections and stress that can occur. This can also allow maximum strength subject to the geometric constraints.

Like the strut angle, the deflections also change as the sprag rotates under load. The outer race expands while the inner race and the sprags are compressed. These deflections can be important if they are too great, such that the sprag can easily rollover. Essentially, the cam rise of the sprag as it rotates in engagement typically should be greater than the absolute values of the system deflections.

Cam Rise≧|ΔORᵢₙₙₑᵣ|+|ΔIRₒᵤₜₑᵣ|+|δ|+K_{C}

where K_{C} is the radial stack-up of clearances in the clutch system, based off of manufacturability.

Stress induced in the three main parts of the clutch are discussed next. There are two interfaces for analysis: the inner radius of the outer race with sprag and the outer radius of the inner race with sprag. The former is a concave/convex interaction, and the latter is convex/convex interaction. The non-conformal contact induces the greater stress.

The stress between two convex surfaces, the inner race and the sprag, is defined by the hertz stress

$${σ}_{c ( max )} = \sqrt{\frac{2 * {F}_{inner} * ( \frac{1}{{OR}_{inner}} + \frac{1}{{OR}_{sprag}} )}{π * {W}_{sprag} * 4 * ( \frac{1 - {v}_{inner}^{2}}{{E}_{inner}} + \frac{1 - {v}_{sprag}^{2}}{{E}_{sprag}} )}} \qquad ( 6 )$$

where OR_{sprag} is defined as half of the nominal sprag height.

$${OR}_{sprag} = \frac{{h}_{nom}}{2} \qquad ( 7 )$$

A derivation of the max Hertz stress equation is the mean Hertz stress equation and is defined by

$${σ}_{c ( mean )} = \frac{1}{2} * \sqrt{\frac{{F}_{inner} * π * ( \frac{1}{{OR}_{inner}} + \frac{1}{{OR}_{sprag}} )}{{W}_{sprag} * 4 * ( \frac{1 - {v}_{inner}^{2}}{{E}_{inner}} + \frac{1 - {v}_{sprag}^{2}}{{E}_{sprag}} )}} \qquad ( 8 )$$

Rearranging the previous equation to provide a constant for future equations, c₁, allowing for a function strictly in terms of the material properties to assist in iterations.

$${c}_{1} = \frac{1}{2} \sqrt{\frac{π}{{W}_{sprag} * 4 * ( \frac{1 - {v}_{inner}^{2}}{{E}_{inner}} + \frac{1 - {v}_{sprag}^{2}}{{E}_{sprag}} )}} \qquad ( 9 )$$

The mean contact stress equation can then be set to solve for the total force per sprag, F₍ᵢ₎, in the next equation.

$${F}_{inner} = \frac{{W}_{sprag} * ( \frac{{{σ}_{c ( mean )}}^{2}}{{c}_{1}} )}{\frac{1}{{OR}_{sprag}} + \frac{1}{{OR}_{inner}}} \qquad ( 10 )$$

Equation 10 provides a second equation to solve for the total force per sprag due to Equation 2, previously derived. The two equations can then be set equal to one another and arranged to solve for the outer race inner radius. The result of Equation 11 can have a positive and negative root due to the quadratic nature of this equation. The negative result can be neglected and the positive is the only value of interest.

$${OR}_{inner} = \frac{{T}_{inner} \pm \sqrt{\begin{matrix}{T}_{inner}^{2} - 4 * ( {OR}_{sprag} * {N}_{sprag} * sin ( {α}_{inner} ) * \\ {w}_{sprag} * {( \frac{{σ}_{c ( mean )}}{{c}_{1}} )}^{2} ) * ( - {T}_{inner} * {OR}_{sprag} )\end{matrix}}}{2 * ( {OR}_{sprag} * {N}_{sprag} * sin ( {α}_{inner} ) * {( \frac{{σ}_{c ( mean )}}{{c}_{1}} )}^{2} )} \qquad ( 11 )$$

According to application history, sprag one-way clutch systems typically limit the mean contact stress to approximately 3.45 GPa. Note that contact stresses vary due to the strut angle in the design of the sprag and therefore should to be determined iteratively.

The arrangement of sprags dispersed between the races creates circumferential stress, otherwise known as hoop stress, in the inner and outer races. The inner race experiences compressive stresses and as a result does not typically experience fatigue failure. The outer race, however, experiences tensile hoop stresses, which is a typical mode of fatigue failure for steels (tension leads to crack propagation). Therefore, the analysis of the hoop stress in the outer race is the issue.

The number of sprags dispersed between the races also can greatly reduce the bending stress experienced in the outer race which can contribute to hoop stresses. If the number of sprags is greater than eight (8), then the hoop stress is mainly (12) produced from circumferential stresses. The result is the following equation as a function of the pressure applied to the interior surface of the outer race, Qₒᵤₜₑᵣ, and the wall thickness of the outer race.

$${σ}_{h ( mean )} = {Q}_{outer} * ( \frac{{OR}_{outer}^{2} + {IR}_{outer}^{2}}{{OR}_{outer}^{2} - {IR}_{outer}^{2}} )$$

The pressure on the interior surface of the outer race is determined by a function of the radial force per sprag, the number of sprags and the total inner surface

$${Q}_{outer} = {F}_{outer} * ( \frac{{N}_{sprag} * cos ( {α}_{outer} )}{2 * π * {IR}_{outer}^{2} * {W}_{outer}} ) \qquad ( 13 )$$

Assuming that the width of the sprag is equal to the width of the outer race, Equations 10 and 13 can be substituted into Equation 12 to give the following equation for the mean hoop stress in the outer race.

$${σ}_{h ( mean )} = {( \frac{{σ}_{c ( mean )}}{{c}_{1}} )}^{2} * ( \frac{{OR}_{outer}^{2} + {IR}_{outer}^{2}}{{OR}_{outer}^{2} - {IR}_{outer}^{2}} ) * ( \frac{{OR}_{sprag} * {OR}_{inner} * {N}_{sprag} * cos ( {α}_{outer} )}{( {OR}_{sprag} + {OR}_{inner} ) * 2 * π * {IR}_{outer} )} ) \qquad ( 14 )$$

The average hoop stress is then assumed based on stresses found in common applications of sprag clutches. This assumption allows for Equation 14 to be solved in terms of the outer radius of the outer race given the pressure, Q₍ₒ₎, in Equation 13.

$${OR}_{inner} = \sqrt{\frac{{Q}_{outer} * {IR}_{outer}^{2} + {σ}_{h ( mean )} * {IR}_{outer}^{2}}{{σ}_{h ( mean )} - {Q}_{outer}}} \qquad ( 15 )$$

The next points of interest in the outer race of the sprag clutch analysis is the outer radius directly above the sprag and at the inner radius at the midway point between the sprags. The first variable to be defined is the half angle between sprags.

$$Φ = \frac{π}{{N}_{sprag} } \qquad ( 16 )$$

The next variable is the offset between the neutral axis and the centroid of the outer race is then defined as a function of the outer race thickness and the mean radius of the outer race, R_{mean,outer}.

$${e}_{outer} = \frac{{h}_{outer}^{2}}{12 * {R}_{mean , outer}} * ( 1 + \frac{{h}_{outer}^{2}}{15 * {R}_{mean , outer}^{2}} ) \qquad ( 17 )$$

Using the previously derived variables from Equations 16 and 17, the hoop stress at the outer radius above the sprag is defined in the following equation.

$${σ}_{hover , outer} = \frac{{F}_{normal , outer}}{2 * {A}_{outer} * tan ( Φ )} - \frac{{F}_{normal , outer} * {R}_{mean , outer}}{2 * {A}_{outer}} * ( \frac{1}{tan ( Φ )} - \frac{{R}_{mean , outer} - {e}_{outer}}{Φ * {R}_{mean , outer}} ) * ( \frac{{OR}_{outer} - ( {R}_{mean , outer} + {e}_{outer} )}{{e}_{outer} * {OR}_{outer}} ) \qquad ( 18 )$$

The hoop stress at the inner radius of the outer race midway between the sprags is defined using the same variables previously mentioned as well as the inner radius of the outer race.

$${σ}_{hbetween , outer} = \frac{{F}_{normal , outer}}{2 * {A}_{outer} * sin ( Φ )} - \frac{{F}_{normal , outer} * {R}_{mean , outer}}{2 * {A}_{outer}} * ( \frac{1}{sin ( Φ )} - \frac{{R}_{mean , outer} - {e}_{outer}}{Φ * {R}_{mean , outer}} ) * ( \frac{{OR}_{outer} - ( {R}_{mean , outer} + {e}_{outer} )}{{e}_{outer} * {IR}_{outer}} ) \qquad ( 19 )$$

### Results and Discussion

There are three components that the foregoing equations were used to determine for the final dimensions. Those components include the inner race, outer race, and the sprags. The first dimension to calculate was the minimum outer radius of the inner race, about 6.5 mm, which is below what is required to allow an axle to fit through and resist the compressive loads. The outer radius of the inner race was then chosen to be about 8.5 mm. This size may need to be adjusted, ideally decreasing it, after initial testing of the apparatus. As its thickness increases, the thinner the outer race becomes which should be avoided. This allows the strength of the outer race to be maximized and is necessary because it is the only component under tensile loads.

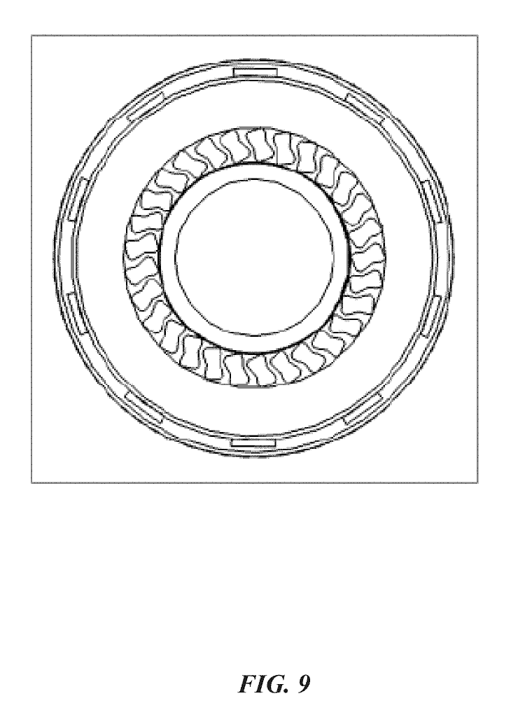

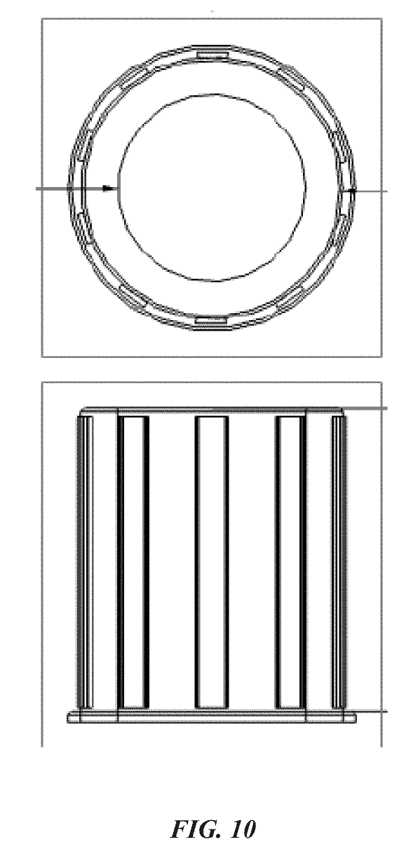

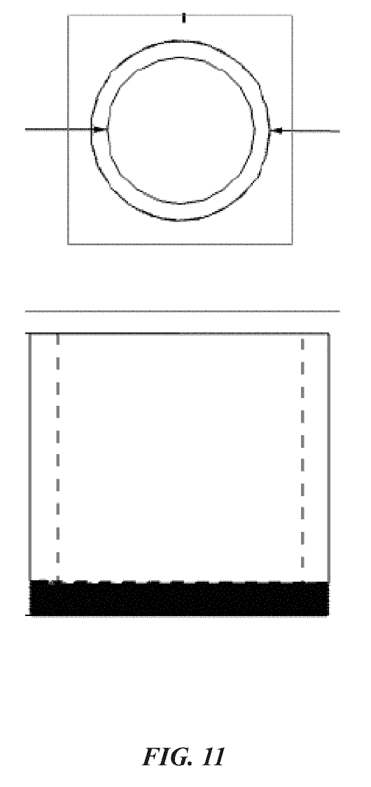

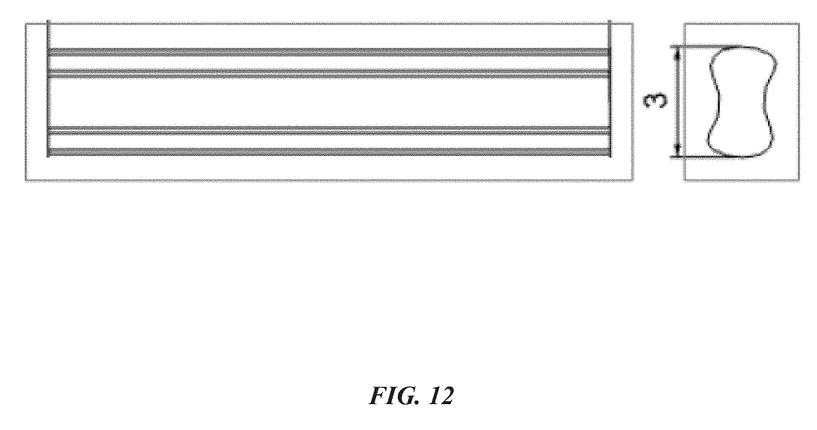

Before determination of the outer race dimensions, two dimensions for the sprag were assumed. First is its nominal height, about 3 mm. The inner radius of the outer race, around 11.5 mm, is the sum of the outer radius of the inner race and the nominal height of the sprags, or the height at which the sprags assume during freewheel operation, not engaged. This height may also be important to the strength of the outer race, again the thickness is a function of the height. Second is the sprag's width, about 15 mm. This was determined from the SHIMANO inner core where the paws are located; consequently, the ratchet is along the inside of the cassette driver outer shell. This width had to fit in between the drive side bearing race and the splines of the cassette driver/hub interface (FIGS. 9-12). Maximizing this width minimizes the necessary thickness of the outer race. It should be noted that this width can change depending on the methodology used to mate the cassette driver to the hub.

Additionally, the outer radius of the outer race was determined to be a minimum of about 16.1 mm by using Equation 15. The maximum outer radius of the outer race, about 16.25 mm, is constrained by the splined interface of the cassette driver/cassette. Thus, the dimensions calculated meet this constraint and the sprag clutch cassette driver is able to be integrated. Table 1 lists the calculated dimensions.

TABLE 1
Comparison of SHIMANO Freehub and Sprag Clutch race dimensions.

| Dimension | SHIMANO | Sprag Clutch |
|---|---|---|
| Outer Race Outer Radius (mm) | 16.25 | 16.1 |
| Outer Race Inner Radius (mm) | 13.53 | 11.5 |
| Inner Race Outer Radius (mm) | 12.02 | 8.5 |
| Inner Race Inner Radius (mm) | 6.95 | 6.95 |

The results listed in Table 1 show that the sprag clutch was able to be designed to be within the dimensions of the existing system. This would imply that the sprag clutch design could be manufactured and interchanged with the existing ratchet and pawl systems, and still allow for compatibility with a multitude of rear hubs. The goal, to determine if a sprag clutch could be interchanged in a SHIMANO HYPERGLIDE freehub with minimal amount of changes to the existing structure, was achieved.

The first iteration of determining dimensions resulted in the outer race being larger than the outer race of the SHIMANO freehub. This is plausible, but undesirable as it would require a new design of the cassette/cassette driver interface and reduce motivation for cyclist's endorsement. Instead, the static coefficient of friction was increased, which increased the strut angle, and as a result decreased the force between the sprags and the races. The increase of the static coefficient can be important in the overall design and reliability. It must be attainable for the sprag clutch or it may not be a feasible design. This allowed the reduction in the outer radius of the outer race and in doing so fits into the constraint of the standard cassette/cassette driver interface. This was the primary concern, but it is believed that initial testing may allude to other dimensions to be modified, i.e. the sprag nominal height and the thickness of the inner race.

### Final Design

For minimal amount of component adjustments, other parts of the cassette driver were intended to be held constant so as to minimize cost and stress analysis. This includes the cassette driver body fixing bolt, axle ball bearing race, clutch bearings, axle, cassette driver/rear hub interface and the cassette/cassette driver interface so that the motivation to convert is maximized. More so, the final design can be imagined as removing the pawl and ratchet clutch and replacing it with the sprag clutch as seen in FIGS. 9-12.

After considering any options of adjusting assumptions made such as the mean hoop stress, an inexpensive and easily implemented alternative was determined. This means that with the constructed sprag system could reduce the size of the outer race of SHIMANO's hubs and potentially create a component that is stronger than it is required to be.

### Sprag Cage

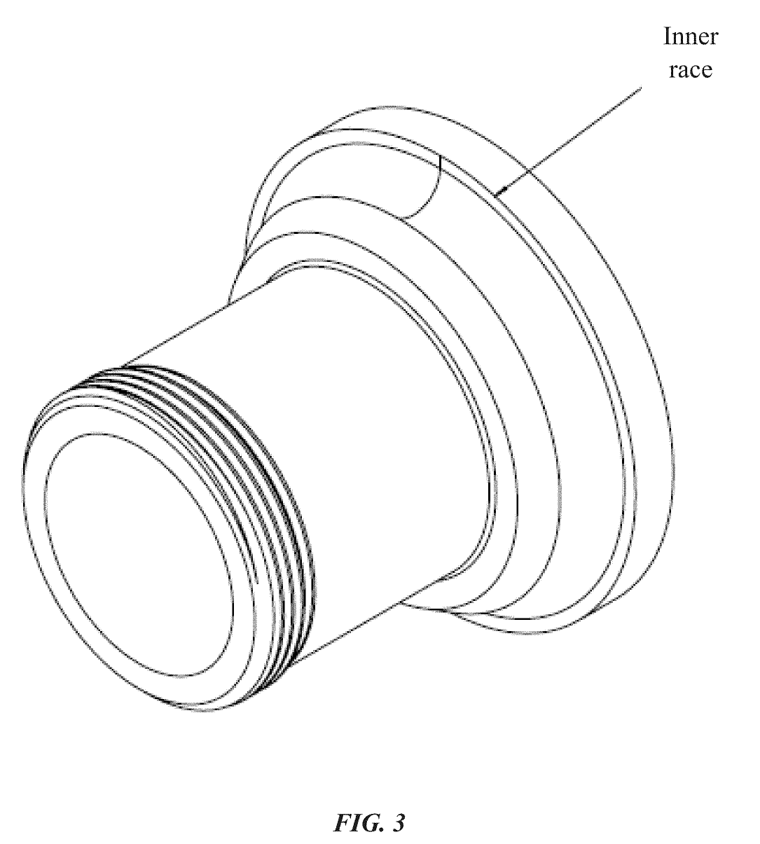

In certain embodiments, the current invention includes a sprag cage to constrain the sprags' movement while maintaining the sprags properly oriented during operation. The sprag cage is seated between the inner and outer races of the sprag clutch assembly. When a sprag cage is not present, the inner race can include a lip at its threaded end to provide a similar function. When a sprag cage is present, this lip is removed (see FIG. 3) to allow the sprag cage to slide over the inner race.

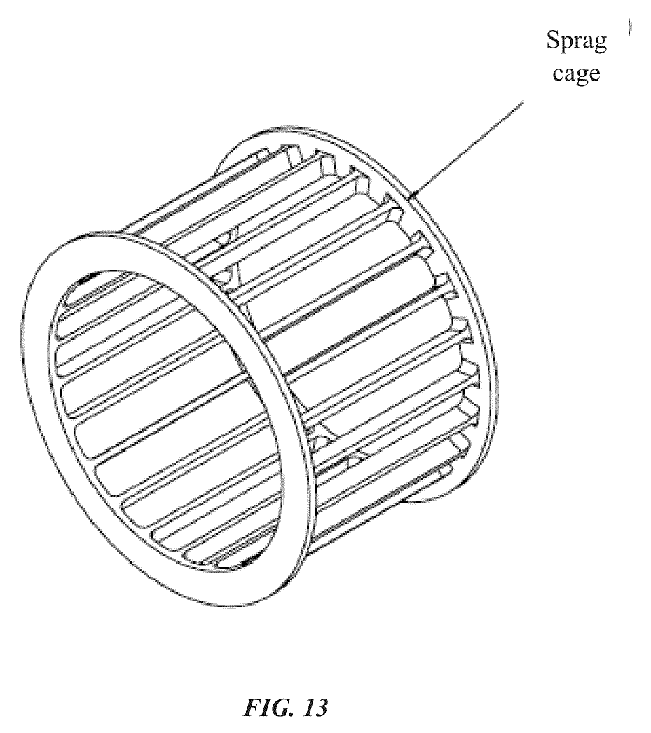

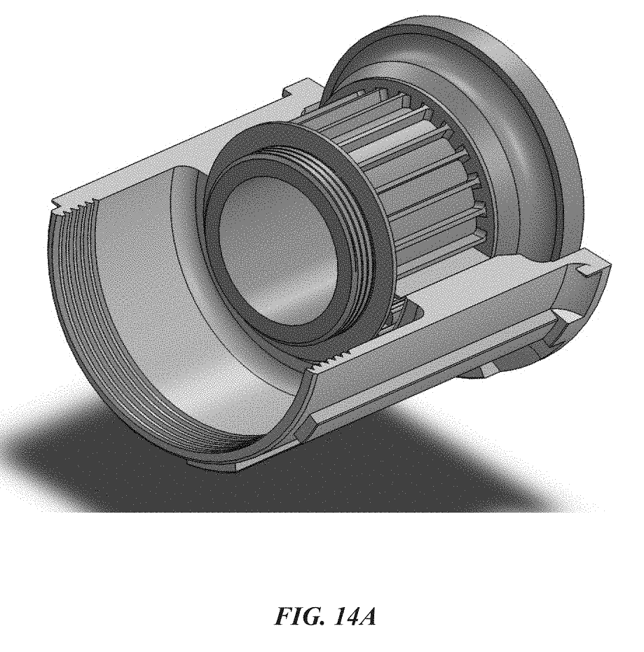

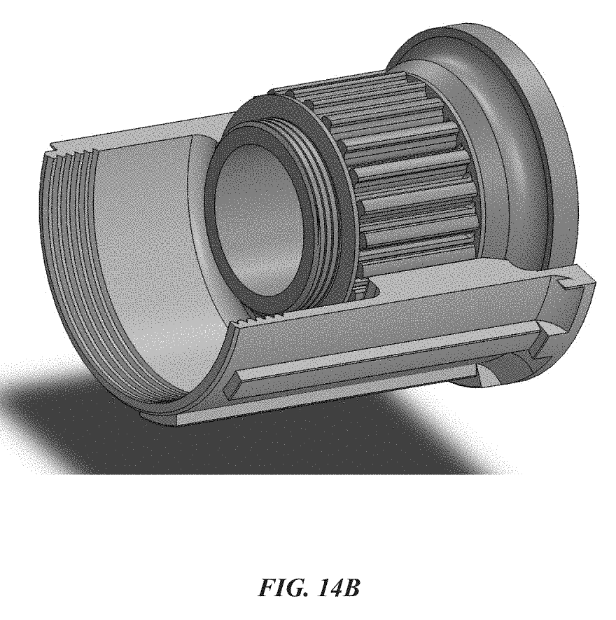

The sprag cage serves as a framework to support and properly position the sprags. The sprag cage ensures the sprags remain evenly spaced such that the sprags are not able to interfere with one another. The slots of the sprag cage that hold the sprags allow for sufficient space such that the sprags can properly pivot to engage and space for the sprags to return to an optimal resting position, where the resting position includes the angle at which the sprags can lay down to allow freewheeling. The sprag cage also restricts the sprags from completely toppling over and causing the assembly to seize up. See FIGS. 13 and 14A-14B.

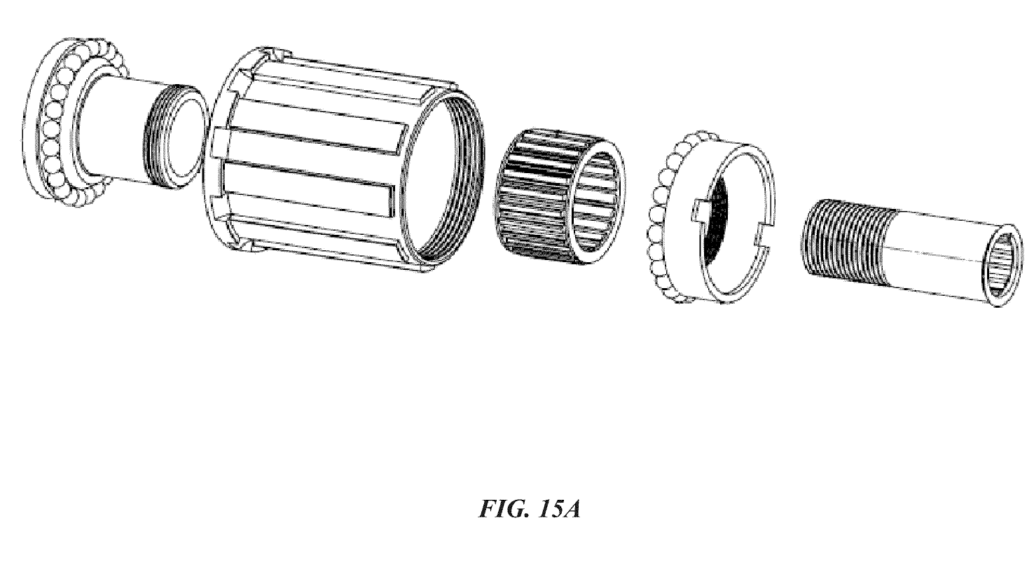

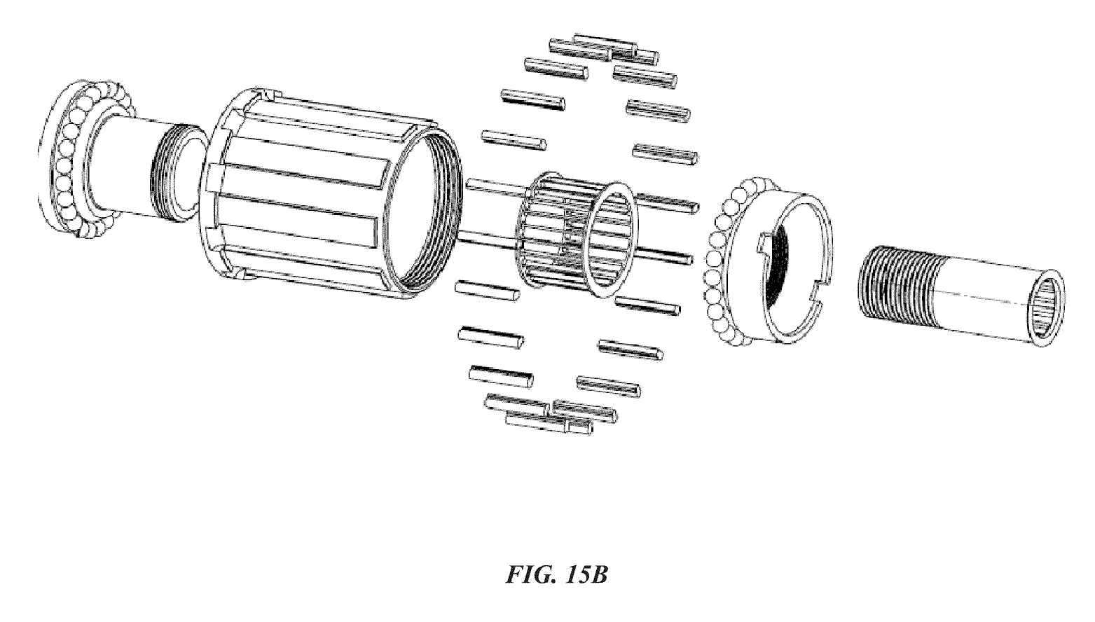

FIGS. 15A-15B are exploded views of an embodiment of the current invention when the sprag cage is used.

### Testing

Described herein are the methods of designing and testing a sprag clutch system for bicycle cassette drivers to replace existing pawl and ratchet systems. The design methods describe how to properly size and analyze the necessary components in the sprag clutch assembly. The methods include stress analysis with strain gauges, FEA, friction-loss tests, engagement gap measurements and impact-loading tests. Results provide a performance comparison of the designed sprag clutch cassette driver and commercially available cassette drivers.

It is an object of this testing to replace the ratchet and pawl system in a mountain bike hub with a sprag OWC system according to certain embodiments of the present invention in order to increase the performance and durability of the system.

The sprag clutch to be made is designed to ensure all areas of improvement. The performance increase ultimately comes from near-instantaneous engagement when pedaling unlike in the ratchet and pawl system that has a much larger distance to travel before engagement. The new design would allow for a sprag clutch system to replace existing standard ratchet and pawl systems in bike hub housings. The conversion to a sprag clutch would allow for a simple and cost effective way for cyclists to increase the overall performance of their machine.

The sprag clutch design ensures the aforementioned qualities meet or exceed current bicycle clutches. The new clutch performance increases results from the reduction of rotation required before engagement within the hub when applying force to the pedals. Additionally, the sprag clutch smooth engagement minimizes friction loss during free-wheeling, thus increasing drivetrain efficiency. This design would allow for the sprag clutch system to seamlessly replace existing bicycle hub housings. The conversion to a sprag clutch would allow for a simple and cost effective way for cyclists to increase the overall performance of their bicycle.

It is an object of the present testing to provide for a comparison between the designed sprag clutch and conventional bicycle hubs. The data accumulated from the experiments can be used to verify an industry average assumption used in the original design of the sprag clutch. Verification of the performance improvements can be quantified by these tests. The tests can measure the stress, friction loss during free-wheeling, distance traveled before engagement, and service life of the sprag clutch system.

### Methodology—Sprag Clutch Free Hub Friction Test Plan

Objective: To quantify frictional forces of contemporary pawl and ratchet bicycle free hub clutch mechanisms and compare with a sprag one-way clutch mechanism with the energy method.

It is an object of this methodology to build a test stand that is rigid and interchangeable with all free hubs testing. The test stand should be mountable and level to a surface. The inner bearing of the free hub can be locked and prevented from rotating by way of mounting to stand. Thus, the free hub can only freewheel in one direction, but stopped if the direction of the outer shell is reversed. The axis of rotation of the free hub must be perpendicular to the vertical axis to properly assess only friction. A prescribed mass can be set upon a mass carriage. This carriage is connected to the free hub by wire. The wire is wrapped around the free hub.

There can be two cases. The first is when there is just enough mass to trip the static friction in the freewheeling direction of the free hub. This is recorded as the static frictional force that begin freewheeling. The second is when the mass falls at a constant rate, g. The carriage is set free and the distance the mass travels in a given moment is then recorded. This is the dynamic frictional force; it balances the falling mass and the mass moment of inertia of the outer shell, along with the bearings and sprags (rolling resistance for the bearings). These tests are done n times to create an average friction force, static and dynamic.

### Methodology—Impact Loading Test Plan

Objective: Measure wear and fatigue of various bicycle hub clutch mechanisms including the designed sprag clutch.

The test bicycle can be set up on a bicycle trainer. The bicycle trainer can support the rear wheel off of the ground to allow the rotation of the crank without interference. Attached to one of the pedals can be a double acting pneumatic cylinder with a complete setup to extend and retract the cylinder arm. The setup can also include an Arduino circuit programmed to activate one solenoid of a double solenoid valve at a time. The solenoid can be attached to an air compressor that allows air flow into one inlet on the pneumatic cylinder at a time to repeatedly apply a force to the pedal. The force applied by the pneumatic cylinder can equal the max load applied by a typical cyclist putting their entire weight on one pedal (800N based off an average rider weight of 180 lbs).

The aforementioned setup can repeatedly apply an impact load to each hub that is to be tested. After defined number of cycles, each hub can be disassembled to compare wear and fatigue of each clutch mechanism (ratchet and pawl compared to sprag). The sprags can be measured with a micrometer and weighed before testing and after testing to identify whether any material was lost due to the impact loading. The same can be done with the pawls of the other various hubs that are to be tested.

### Methodology—Strain Gauge Test Plan

Objective: Apply a torque to the hubs with strain gauges attached to determine the stress exerted on the outer race of the various hubs to be tested.

The test bicycle can be mounted in the bicycle trainer to raise the rear wheel off the ground. The rear wheel can then be locked in place through the hand brake being clamped down with alligator clips. Once the wheel is secure, strain gauges can be applied to the rear hub outer race in a Wheatstone bridge configuration with a dummy temperature compensation strain gauge to ensure accuracy. A weight can then be placed on the right pedal that can equal the weight of the average male rider (180 pounds or 800N).

The strain gauge configuration allows for recording of the proper data needed to find the strain in the outer race. The test setup can then be applied to multiple hubs to determine how each one behaves under the same load. The data recorded in this test should also allow for the confirmation of FEA analysis performed on hubs as well as assumptions made in the design of the sprag clutch.

### Methodology—Life Cycle Test Plan

Objective: Collect data on the wear of the hub and determine if the hub meets a minimum life cycle requirement.

During the design process, assumptions are made based on previous designs of the current and conventional sprag clutches. The following parameters were given assumed values based on industry standardized values and reference [1]: a mean contact stress value of 3.45 GPA, and a possible sprag strut angle of about 5°.

### REFERENCES

1. Chesney, David R., Kremer, John M. “Generalized Equation for Sprag One-Way Clutch Analysis and Design.” SAE Technical Paper Series 981092 (1998): 1-13. Print

2. Norton, Robert L. Machine Design: An Integrated Approach. Upper Saddle River, N.J.: Pearson Prentice Hall, 2006. Print.

3. Childs, Peter Mechanical Design. Butterworth Heinemann, London, 2003. University of Sussex.

4. Skip Gibbs. “Motion System Design.” Machine Design. The Hilliard Corp, 1 Aug. 2000. Web. 10 Dec. 2015.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A sprag clutch and cassette driver assembly, comprising:
a sprag clutch positioned in an annular cavity within a cassette driver of a bicycle,
said sprag clutch including sprags contacting an exterior surface of an inner race and an interior surface of a shell of said cassette driver,
wherein said sprags only contact surfaces within said cassette driver.

2. A sprag clutch and cassette driver assembly as in claim 1, further comprising a sprag cage seated between said inner race and said outer race, wherein said sprag cage includes slots that hold said sprags in a spaced apart position such that said sprags can pivot to engage and can return to a resting position.
